(19) United States
(12) Patent Application Publication
(10) Pub. No.: US 2024/0380059 A1
(43) Pub. Date: Nov. 14, 2024

(54) Battery Cell Pack for a Battery, and Battery

(71) Applicant: BAYERISCHE MOTOREN WERKE AKTIENGESELLSCHAFT, Muenchen (DE)

(72) Inventors: Robert LOCH, Muenchen (DE); Christoph WARKOTSCH, Muenchen (DE)

(21) Appl. No.: 18/686,165

(22) PCT Filed: Aug. 2, 2022
(86) PCT No.: PCT/EP2022/071680

§ 371 Date: Feb. 23, 2024

(30) Foreign Application Priority Data
Aug. 26, 2021 (DE) 10 2021 122 106.4

(51) Int. Cl. H01M 50/293; H01M 50/242; H01M 50/249

(52) U.S. Cl. CPC H01M 50/293; H01M 50/242; H01M 50/249

(57) ABSTRACT

A battery cell pack includes a multiplicity of battery cells arranged next to one another. A multiplicity of frame elements corresponds geometrically to the battery cells. A battery cell is positionally fixed by means of two of the frame elements directly adjacent to each other by the corresponding battery cell being inserted into a battery cell space formed by the two directly adjacent frame elements. An intermediate layer is arranged directly between the respective battery cell and the frame elements, such that the respective battery cell is held in the battery cell space via the intermediate layer. The intermediate layer is elastically compressible, without destruction, by a swelling of the directly adjoining battery cell to a swelling extent, as a result of which, despite the swelling of the corresponding battery cell, a size of the battery cell space and therefore external dimensions of the battery cell pack remain constant.

### BACKGROUND AND SUMMARY

The present disclosure relates to a battery cell pack, in particular having solid-state battery cells, and to a battery, in particular for a vehicle which is at least partially electrically drivable, or has at least partially electric drive capability.

A motor vehicle which is at least partially electrically drivable, or has at least partially electric drive capability, for example a hybrid vehicle, an electric vehicle, etc. comprises a battery, in particular a secondary battery, for storing and providing electrical energy for driving the motor vehicle via an electromechanical energy converter. To this end, the battery comprises a multiplicity of battery cells, which are in the form, for example, of respective pouch cells. The battery cells are repeatedly charged and discharged during operation of the motor vehicle, each respective battery cell having different outer dimensions, that is to say different dimensional extents, in the discharged state and in the charged state. Owing to this change in extent occurring during operation of each respective battery cell, it is necessary to provide design measures to absorb or compensate for the change in spatial extent in the installation position of the battery cells. The change in spatial extent is expressed in an up to 10% difference in volume per battery cell between the charged and the discharged state.

DE 10 2017 008 390 A1 proposes a battery with at least one battery cell and an electrical conductor. The electrical conductor is arranged meanderingly, as a result of which the electrical conductor can conjointly perform a dimensional change of the battery cell without damage. DE 11 2012 002 517 T5 and DE 11 2012 002 518 T5 each propose a battery assembly comprising two mutually spaced cell units, wherein the cell units adjoin one another via a spacer element. The spacer element forms a cooling channel. In order to avoid the cooling channel formed by the spacer element being disadvantageously compressed as a result of expansion of the adjacent cell units, the spacer element is configured to prevent the expansion of the cell units.

These conventional battery devices are, however, particularly complex in terms of their design and do not permit “cell-to-pack” integration with a sandwich structure. Rather, these conventional battery devices require at least one “cell-to-module” arrangement, and only then is “module-to-pack” integration possible.

An object of the present disclosure is a particularly advantageous insertion or arrangement of battery cells of which the spatial extent changes between an electrically charged state and an electrically discharged state.

According to the disclosure, a battery cell pack for a battery, in particular a motor vehicle battery, is proposed. In the intended installation position of the battery cell pack, the battery or motor vehicle battery comprises the battery cell pack. The battery cell pack has a multiplicity of battery cells, in particular secondary battery cells, arranged next to one another. In one embodiment of the battery cell pack, it is provided that the respective battery cell is in the form of a solid-state battery cell. In this case, the respective battery cell thus comprises a solid-state electrolyte. In particular, the respective battery cell also does not contain any liquid. Battery cells of this configuration are referred to as ASSB cells (ASSB: all-solid-state battery). Solid-state battery cells have advantages in terms of a particularly high specific energy density and in terms of improved operational reliability.

In any case, the battery cell pack also has a multiplicity of frame elements geometrically corresponding to the battery cells, wherein a battery cell is positionally fixed via two frame elements that are directly adjacent to one another. To this end, the frame elements directly adjacent to one another are arranged one on another such that a battery cell space is formed through these frame elements or between these frame elements. The battery cell is inserted in this battery cell space and as a result positionally fastened or fixed in/to the frame elements that are directly adjacent to one another.

Moreover, the battery cell pack in general for each battery cell has at least one interlayer, which is arranged directly between the respective battery cell and at least one of the frame elements that positionally fixes the corresponding battery cell. As a result, the respective battery cell is held in the battery cell space via the interlayer. In other words, via the interlayer, the battery cell makes contact with one of the frame elements or both frame elements that together form the battery cell space in which the battery cell is to be inserted.

The interlayer has a non-destructively elastically compressible form. Accordingly, the interlayer can be non-destructively elastically compressed by the battery cell in that the battery cell inserted in the battery cell space and thereby adjoining the one or more interlayers swells to a swollen size. In this case, the swollen size of the corresponding battery cell is greater than a basic (non-swollen) size of the corresponding battery cell. The swelling of the battery cell from this basic size to the swollen size is associated, for example, with a current state of change (SOC). As a result, the battery cell in a discharged state (SOC=0) has the basic size, whereas the battery cell in the charged state (SOC>0) has the swollen size. If the battery cell has the swollen size, it is larger in at least one spatial direction than if the battery cell has the basic size. Expressed more simply, the battery cell is wider and/or longer and/or deeper when it has the swollen size than when the battery cell has the basic size.

In the battery cell pack, a size of the battery cell space-in particular in the three spatial directions—and consequently outer dimensions of the battery cell pack thus remain(s) constant in spite of the swelling of the corresponding battery cell. This is because the change in size of the corresponding battery cell inside the battery cell space as it swells is absorbed or compensated by the one or more interlayers in that the respective interlayer is compressed by the swelling of the corresponding battery cell inside the battery cell space. This means that, for example, a thickness of the respective interlayer is changed by the swelling or swollen battery cell exerting a compressive force on the respective interlayer. This compressive force deforms, for example compresses, the interlayer. In the process, the frame elements which together form the battery cell space remain relatively unmoved with respect to one another, with the result that the swelling of the battery cell outside the battery cell space is not reflected in a change in size. The geometry and outer dimensions of the frame elements thus remain constant on the outside irrespective of whether the battery cell has the basic size or the swollen size. Dimensions of the frame elements, in particular of the battery cell space, thus do not change during cyclization of the battery cell.

It is therefore advantageously possible to represent a cell-to-pack structure at the system level. In particular, it is possible to arrange the battery cell pack having the multiplicity of battery cells in a sandwich structure and in particular to integrally bond, for example adhesive bond, this battery cell pack to a housing element and/or load-bearing element. For example, it is thus possible to adhesively bond the battery cell pack to a housing top side and to a housing bottom side of a battery housing. This sandwich structure allows the battery cell pack to act as a load-bearing element for the battery and/or for the motor vehicle comprising the battery. For example, a body structure is stiffened owing to the sandwich structure of the battery cell pack. If such a battery cell pack or a battery comprising this battery cell pack is used in the motor vehicle, the result is a particularly advantageous NVH (noise, vibrations, harshness) quality, since the battery cell pack or the battery has particularly few, in particular no, components that can generate disruptive noises. The described structure of the battery cell pack also makes it possible to use the battery cell pack itself as a load-bearing element. Furthermore, the battery cell pack can be advantageously incorporated in existing integration processes in the production of batteries or motor vehicles, without it being necessary to extensively adapt these integration processes to the battery cell pack.

An inhomogeneous distribution of the pressure acting on the respective battery cell promotes the growth of dendrites inside the battery cell and ultimately the destruction of the battery cell. A pressure distribution over the cell which is as uniform as possible over the surface area is ensured via the interlayer, which is attached on/to the battery cell in particular over its entire surface area, with the result that an entire broad side of the battery cell is covered by the interlayer.

In another embodiment of the battery cell pack, the respective interlayer comprises a material which has a Poisson ratio or Poisson number (u) of less than 0.3, that is to say μ<0.3, in particular μ<0.2, for example μ=0.1. In particular, the respective interlayer is made from such a material having this low Poisson ratio u. Owing to this particularly small Poisson ratio u, when compressed along a compression axis the interlayer does not undergo, or undergoes only very little, increase in a dimension transverse to the compression axis. This ensures that the interlayer does not undesirably press against the one or more frame elements transversely to a swelling direction of the battery cell as the latter swells. As a result, the battery cell pack is particularly dimensionally stable, irrespective of whether the respective battery cell has the basic size or the swollen size.

In an embodiment of the battery cell pack, it is provided that the respective interlayer comprises a foamed material, in particular a polyurethane foam. Use is made in particular of an open-pore foamed material, in particular an open-pore polyurethane foam, with the result that the change in size owing to the battery cell swelling from its basic size to its swollen size can be absorbed or compensated particularly efficiently.

In order to ensure a particularly lengthy service life and particularly reliable operation of the battery cell pack, according to one embodiment of the battery cell pack, it is provided that the interlayers are each configured, that is designed and arranged, such that an initial pressure acts on the respective battery cell, even if it is not swollen, that is has the basic size. This initial pressure is up to 10 bar, preferably up to 5 bar, in particular up to 1 bar.

According to a further embodiment, the battery cell pack comprises two pressing plates and two clamping elements, in particular clamping straps. The pressing plates delimit the battery cell pack along its direction of longitudinal extent, and are clamped in with respect to one another along the direction of longitudinal extent via the clamping elements or clamping straps. To this end, the clamping elements and the pressing plates are connected to one another by a force fit, a form fit, and/or an integral bond. For example, the clamping elements and the pressing plates are welded, in particular laser welded, clinched, screwed, riveted, adhesively bonded, etc., to one another. The battery cells, the frame elements, and the interlayers are arranged between the pressing plates along the direction of longitudinal extent, with the result that the battery cells, the frame elements, and the interlayers are clamped together via the pressing plates and via the clamping elements. To this end, the clamping elements are subjected to tensile loading between the pressing plates when the battery cells, the frame elements, and the interlayers are arranged between the pressing plates.

In general, it holds true for the battery cell pack that the battery cells, the frame elements, and the interlayers can be arranged in the following order: pressing plate (if present)—interlayer—battery cell—interlayer—frame element—interlayer—battery cell—interlayer—frame element, etc. In terms of the arrangement of the battery cells, the frame elements, and the interlayers, the battery cell pack in particular has a mirror-symmetrical form, with the result that, at a corresponding end of the battery cell pack, a “last” interlayer and then the corresponding pressing plate follow a “last” battery cell.

In an embodiment of the battery cell pack, there are further/other orders for the arrangement of the pressing plates, the battery cells, the frame elements, and the interlayers. For example: pressing plate (if present)—interlayer—battery cell—interlayer—battery cell—interlayer—frame element—interlayer—battery cell—interlayer—battery cell—interlayer—frame element, etc. or pressing plate (if present)—battery cell—interlayer—battery cell—frame element—battery cell—interlayer—battery cell—frame element, etc.

The embodiment of the battery cell pack with the pressing plates and the clamping elements results in a particularly strong and stable structure of the battery cell pack, with the result that the latter can serve as a load-bearing element of the motor vehicle or for the motor vehicle particularly efficiently in terms of resources and/or structural space, for example, in motor vehicle construction.

In another embodiment of the battery cell pack—for example in order to even further assist the advantageously particularly stable structure of the battery cell pack—it is provided that the frame elements are fastened to one another via a connecting element. The connecting element is a force-fitting, form-fitting, and/or integral-bonding element, in particular an adhesive bond. This means that the frame elements are adhesively bonded to one another, for example. In general, the respective frame element of the battery cell pack may be made from a plastic. In this case, it is then conceivable for the frame elements to be integrally bonded to one another via plastics welding. In addition, it holds true generally for the respective frame element that it has a baseplate and a strap attached along an outer edge of the baseplate. The strap projects beyond the baseplate on either side, with the result that the baseplate and the strap form two opposing shells. Accordingly, the respective frame element has an “I” shape when viewed in section. This means that the respective frame element has an upper chord and a lower chord and also a bridging piece connecting the upper chord and the lower chord, wherein the chords are formed by the strap, and the bridging piece is formed by the baseplate. If then—as has already been set out—two of the frame elements (one left-hand and one right-hand frame element) are directly adjacent to one another, the battery cell space is delimited on the inside by the two bridging pieces and the respective chords, wherein a shell on the left side of the right-hand frame element and a shell on the right side of the left-hand frame element together form the battery cell space. If the frame elements are connected to one another by a form fit, force fit, or integral bond, it may be provided that the frame elements are connected to one another at the respective upper chord and at the respective lower chord—that is via the respective strap.

In a refinement of the battery cell pack, it has a further connecting element which fastens the frame elements to the clamping elements. The further connecting element may have the same or a similar form to the (first) connecting element set out above. It may also be provided that the first connecting element and/or the further, or second, connecting element has a dual functionality, specifically is used—firstly—to mutually connect the frame elements and—secondly—to connect the frame elements to the clamping elements. In this respect, it can be provided that the battery cell pack only has a single connecting element, specifically either the first connecting element or the second connecting element.

Since the frame elements are fastened to the clamping elements via the first and/or the second connecting element, the advantageously particularly strong and stable structure of the battery cell pack is further supported.

The present disclosure also relates to a battery, in particular for a motor vehicle, which comprises a battery cell pack designed according to the above description. The battery, in particular secondary battery, can be referred to as high-voltage storage unit. For example, the battery comprising the battery cell pack or multiple battery cell packs may serve as a traction battery for the motor vehicle, wherein the motor vehicle is then at least partially electrically drivable, or has at least partially electric drive capability. In this respect, the motor vehicle is, for example, a hybrid motor vehicle, an electric motor vehicle, etc. The motor vehicle is in particular in the form of a passenger car and/or truck. However, this does not rule out use of the battery or the battery cell pack for other applications (marine sector, aviation sector, etc.).

Features, advantages, and advantageous embodiments of the battery cell pack according to the disclosure are to be considered features, advantages, and advantageous embodiments of the battery according to the disclosure, and vice versa.

According to one refinement of the battery, it has a battery housing formed by a housing bottom part and at least one housing top part. The one or more battery cell packs and the housing bottom part are adhesively bonded to one another by a first adhesive bond, wherein the battery cell pack and the housing top part are adhesively bonded to one another by a second adhesive bond. In particular, it is provided that the battery cell pack, the housing bottom part, and/or the housing top part are adhesively bonded to one another via the clamping elements or clamping straps.

This means that the adhesive bond both makes contact directly with the housing bottom part and/or housing top part, and also makes contact with the corresponding clamping strap. Expressed differently again, the housing bottom part and the battery cell pack, and the housing top part and the battery cell pack, are integrally bonded to one another by arranging the adhesive bond(s) between an upper one of the clamping elements and the housing top part and between a lower one of the clamping elements and the housing bottom part.

The disclosure also relates to a motor vehicle comprising at least one battery designed according to the above description. Features, advantages, and advantageous embodiments of the battery according to the disclosure are to be considered features, advantages, and advantageous embodiments of the motor vehicle according to the disclosure, and vice versa.

Further features of the disclosure can emerge from the claims, the figures and the description of the figures. The features and combinations of features cited above in the description and the features and combinations of features shown below in the description of the figures and/or shown solely in the figures can be used not only in the respective specified combination but also in other combinations or individually without departing from the scope of the disclosure.

### BRIEF DESCRIPTION OF THE DRAWINGS

In the drawing:

FIG. 1 shows a perspective view of a battery cell pack;

FIG. 2 shows an exploded illustration, in section along a sectional plane II-II (see FIG. 1), of the battery cell pack;

FIG. 3 shows a view, in section along the sectional plane II-II, of the battery cell pack in the assembled state; and

FIG. 4 shows a plan view of a battery comprising two battery cell packs.

Elements that are the same and have the same function are provided with the same reference signs in the figures.

### DETAILED DESCRIPTION OF THE DRAWINGS

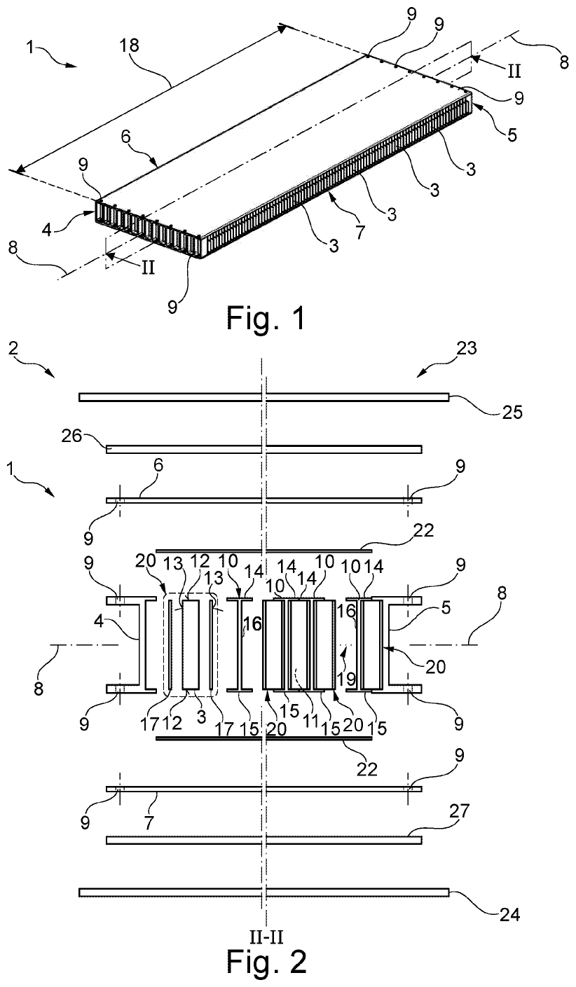

In the following text, a battery cell pack 1, a battery 2 comprising the battery cell pack 1, and a motor vehicle (not illustrated) are set out together in the description. To this end, FIG. 1 shows a perspective view of the battery cell pack 1, which has a multiplicity of battery cells 3 arranged next to one another. Only a few of the battery cells 3 are provided with the corresponding reference signs in FIG. 1. In the present example, the respective battery cell 3 is in the form of a respective solid-state battery cell. This includes the respective battery cell 3 if it merely comprises a solid-state electrolyte and no liquid constituent—however, the disclosure is not restricted to battery cells that do not contain liquids. Rather, in this document the term “battery cell” covers all forms of pouch cells which expand during operation. Accordingly, the respective battery cell 3 or solid-state battery cell is what is referred to as an ASSB cell.

It can also be seen in FIG. 1 that the battery cell pack 1 in the present example has two pressing plates 4, 5 and two clamping elements 6, 7. The pressing plates 4, 5 each laterally delimit the battery cell pack 1 along a direction of longitudinal extent 8. The clamping elements 6, 7, which in the present case are in the form of a respective clamping strap, extend completely along the direction of longitudinal extent 8 of the battery cell pack 1 and are connected to the pressing plates 4, 5 by a force fit, form fit, and/or integral bond. In the present example, the clamping elements 6, 7 or clamping straps and the pressing plates 4, 5 are riveted to one another. In FIG. 1, it is possible to see corresponding rivet points 9, only a few of which have been provided with the corresponding reference signs for the sake of clarity.

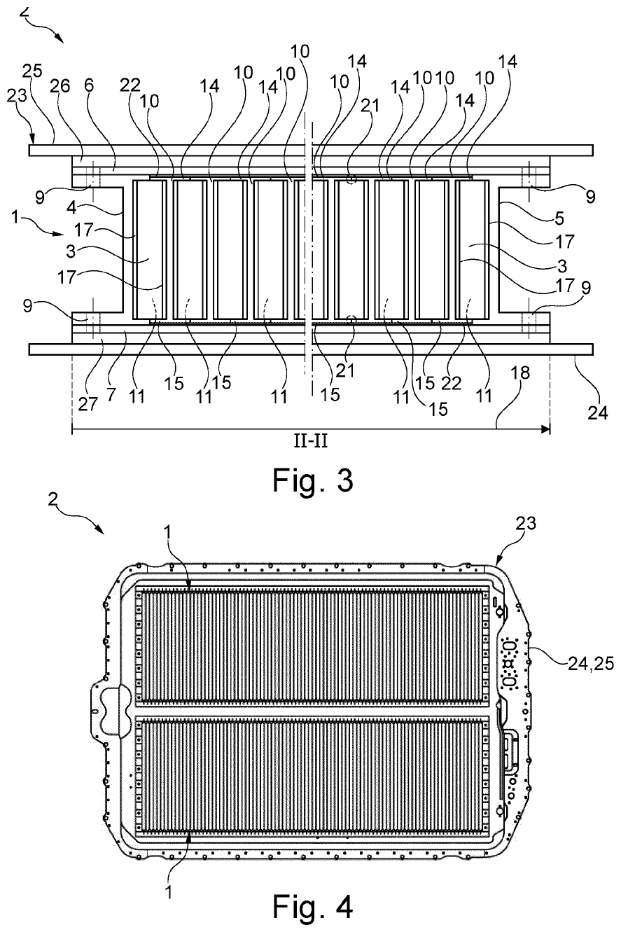

FIG. 2 shows an exploded illustration, in section along a sectional plane II-II (see FIG. 1), of the battery cell pack 1. The battery cell pack 1 has a multiplicity of frame elements 10 geometrically corresponding to the battery cells 3, wherein a battery cell 3 is positionally fixed via two frame elements 10 that are directly adjacent to one another in that the corresponding battery cell 3 is inserted in a battery cell space 11 formed through the two frame elements 10 directly adjacent to one another. In the present case, the respective frame element 10 has a double-shell form with two shells which are mutually opposite or face away from one another, and consequently has a cross-sectional figure in the shape of an I-beam when viewed in section. Furthermore, in the present case, the respective battery cell 3 is formed in accordance with a flat cuboid, wherein respective narrow sides 12 of the battery cell 3 are parallel to the direction of longitudinal extent 8, and respective broad sides 13 of the battery cell 3 are perpendicular to the direction of longitudinal extent 8. A respective upper chord 14 and a respective lower chord 15 of the respective frame element 10 directly adjoin one another in the assembled state (see FIG. 3), wherein the respective battery cell 3 is parallel to a respective bridging piece 16 of the respective frame element 10. The respective battery cell 3 is arranged between the bridging pieces 16 of the frame elements 10.

For each battery cell 3, the battery cell pack 1 has at least one interlayer 17, in the present case two interlayers 17, which are arranged directly between the respective battery cell 3 and the frame elements 10, with the result that the respective battery cell 3 is held in the battery cell space 11 via the interlayers 17. In the case of the battery cell pack 1, it may be provided that it is terminated by a frame element 10, by an interlayer 17 or by a battery cell 3. As has already been set out, in the present example, the battery cell pack 1 is laterally terminated via the pressing plates 4, 5, with the result that the battery cell pack 1 in the present example has two battery cells 3, which adjoin one of the frame elements 10 by way of an interlayer 17 only on one side. In this case, these “last” battery cells 3 adjoin the respective pressing plate 4, 5 on the corresponding other side. This means that, in the present example, two battery cell spaces 11 formed on the one hand by a frame element 10 and on the other hand by the corresponding pressing plate 4, 5 are provided. In this respect, it may be provided that the respective “last” battery cell 3 is at least partially comprised by the respective pressing plate 4, 5.

The respective battery cell 3 has a basic size, that is to say a basic width, a basic length, and a basic depth, wherein the battery cell 3 swells to a swollen size on the one hand throughout its service life and on the other hand with electrical charging. For a new or fresh battery cell 3, it thus holds true that, in the uncharged state (SOC=0), it has the basic size, that is outer dimensions corresponding to the basic size. If the battery cell 3 is electrically charged, the battery cell 3 swells in terms of width and/or length and/or depth. The width and/or the length and/or the depth of the battery cell also increases as the battery cell 3 ages. In order, however, to ensure a constant or consistent length 18 of the battery cell pack 1, irrespective of the state of charge of the battery cells 3 of the battery cell pack 1, and irrespective of a respective age of the battery cells 3 of the battery cell pack 1, the respective interlayer 17 has a non-destructively elastically compressible form. In this respect, the respective interlayer 17 comprises a material with a Poisson ratio u of less than 0.3, that is to say μ<0.3, in particular μ<0.2, for example μ=0.1. In other words, the respective interlayer 17 is at least partially formed by the material having the particularly low Poisson ratio u. In the present case, the respective interlayer comprises a foamed material, in particular, a polyurethane foam. This means that the respective interlayer 17 is at least partially made from the foamed material, for example, the polyurethane foam.

Owing to the respective battery cell 3 swelling to its swollen size, the interlayer 17 is thus non-destructively elastically compressed, with the result that a size of the battery cell space 11, and consequently dimensions, in particular the length 18, of the battery cell pack 1, remain(s) constant in spite of the swelling of the corresponding battery cell 3.

FIG. 3 shows a view, in section along the sectional plane II-II, of the battery cell pack 1 in the assembled state. As already indicated in FIG. 2 by the ellipsis 19, the battery cell pack 1 can be produced with as many units 20 as desired along its direction of longitudinal extent 8, wherein the respective unit 20 has at least one battery cell 3 and one interlayer 17, and in particular, one further interlayer 17. Two units 20 that follow one another along the direction of longitudinal extent 8 make contact via a respective frame element 10. The result is therefore the following arrangement for the battery cell pack 1 along the direction of longitudinal extent 8: pressing plate 4—unit 20—frame element 10—unit 20—frame element 10, etc. After a “last” frame element 10 follows a “last” unit 20, and thereafter the pressing plate 5. The battery cells 3, the frame elements 10, and the interlayers 17 are clamped together between the pressing plates 4, 5 along the direction of longitudinal extent 8. In other words, the units 20 are clamped together between the pressing plates 4, 5 along the direction of longitudinal extent 8. To this end, the clamping elements 6, 7 or the clamping straps and the pressing plates 4, 5 are riveted to one another, and/or otherwise connected to one another by a form fit, force fit, or integral bond, at the rivet points 9. The clamping elements 6, 7 are subjected to tensile loading in the process, with the result that at least the frame elements 10 are clamped together at the respective upper chord 14 and/or at the respective lower chord 15. As an alternative, or in addition, two respective frame elements 10 that are directly adjacent to one another along the direction of longitudinal extent 8 are connected to one another by a form fit, force fit, and/or integral bond via a first connecting element 21. Since the respective frame element 10 in the present example is made from a plastic, the first connecting element 21 may be in the form of a plastics weld. It is also possible for the first connecting element 21 to be in the form of an adhesively bonded point. In particular, the two frame elements 10 directly adjacent to one another are fastened or fixed to one another via their respective upper chord 14 and/or their respective lower chord 15.

As can be seen in FIG. 2 and FIG. 3, in the present example, it is also provided that the frame elements 10 are fastened to the clamping elements 6, 7 via a second connecting element 22. The second connecting element 22 is, for example, an adhesive bond or an adhesive-bonding layer arranged between the chords 14, 15 and the clamping elements or straps 6, 7. Both the respective connection between the two frame elements 10 directly adjacent to one another and the connection between the frame elements 10 and the clamping elements 6, 7 can be established via the first connecting element 21 or via the second connecting element 22. This means that the battery cell pack 1 may have only the first connecting element 21 or only the second connecting element 22, wherein the corresponding connecting element 21, 22 then has a dual functionality.

The respective interlayer 17 is configured such that an initial pressure of up to 10 bar, preferably up to 5 bar, in particular up to 1 bar, acts on the respective battery cell 3 when it is not swollen. This ensures reliable operation of the battery cell 3.

Therefore, if the respective battery cell 3 swells from its basic size to its swollen size, at least one of the interlayers 17, in particular both interlayers 17, that are arranged in the battery cell space 11, together with the battery cell 3, are compressed by the expanding battery cell 3, wherein a geometry and dimensions of the battery cell space 11 are not influenced. In particular, the respective interlayer 17 is compressed by an extent by which the battery cell 3 is enlarged as it swells. The swelling or an increase in size of the battery cell 3 is thus advantageously absorbed or compensated.

FIG. 4 shows a plan view of the battery 2, which in the present case has two battery cell packs 1. The battery 2 is designed, in particular, for an at least partially electrically drivable motor vehicle, that is for a hybrid motor vehicle, for an electric motor vehicle, etc. and can act as a traction battery for the motor vehicle. The battery 2 can be referred to as high-voltage storage unit. According to FIG. 4, the battery 2 comprises a battery housing 23, which is made of a housing bottom part 24 and at least one housing top part 25. The respective battery cell pack 1 is held both on the housing bottom part 24 and on the housing top part 25 by an integral bond in each case. This means that the respective battery cell pack 1 is integrally bonded both to the housing bottom part 24 and to the housing top part 25. In the present example, the respective battery cell pack 1 is adhesively bonded to the housing parts 24, 25 via adhesive bonds 26, 27. The housing parts 24, 25 and the adhesive bonds 26, 27 are illustrated in FIG. 2 and FIG. 3. In FIG. 2 and FIG. 3, it can also be seen that, in the present example, the battery cell pack 1 is adhesively bonded to the housing bottom part 24 and to the housing top part 25 by way of its clamping straps or clamping elements 6, 7, respectively. In this respect, the adhesive bond 26 is between the housing top part 25 and the clamping element 6 of the battery cell pack 1. By contrast, the adhesive bond 27 is between the clamping element 7 and the housing bottom part 24.

It can also be seen that the battery 2 does not have a separate battery housing 23. In this case, the pressing plates 4, 5 and the clamping elements 6, 7 act as an outer surface of the battery 2, as it were as a housing for the battery 2. The particularly stable structure of the battery cell pack 1 makes it possible to dispense with the separate battery housing 23, resulting in a weight advantage.

Overall, the present disclosure provide options for particularly advantageously using or arranging the battery cells 3, the spatial extent of which varies between an electrically charged state and an electrically discharged state. The use or the arrangement of the battery cells 3 is advantageous in particular in terms of a now possible cell-to-pack structure at the system level. Conventional process steps, via which conventional battery cells are firstly arranged according to the cell-to-module principle in order to then arrange the resulting modules according to the module-to-pack principle so as to form a battery module pack can be omitted, this being economically and environmentally favorable. The effect the pressing plates 4, 5 and the clamping elements 6, 7 have on the battery cell pack I is that it has a particularly strong and stable structure, and therefore the battery cell pack I can even serve as a load-bearing structure.

### LIST OF REFERENCE SIGNS

1 Battery cell pack
2 Battery
3 Battery cell
4 Pressing plate
5 Pressing plate
6 Clamping element
7 Clamping element
8 Direction of longitudinal extent
9 Rivet point
10 Frame element
11 Battery cell space
12 Narrow side
13 Broad side
14 Upper chord
15 Lower chord
16 Bridging piece
17 Interlayer
18 Length
19 Ellipsis
20 Unit
21 First connecting element
22 Second connecting element
23 Battery housing
24 Housing bottom part
25 Housing top part
26 Adhesive bond
27 Adhesive bond

1.-10. (canceled)

11. A battery cell pack comprising:
a multiplicity of battery cells arranged next to one another;
a multiplicity of frame elements geometrically corresponding to the battery cells, wherein a battery cell is positionally fixed via two frame elements that are directly adjacent to one another, in that the corresponding battery cell is inserted in a battery cell space formed by the two frame elements that are directly adjacent to one another;
wherein, for each battery cell, an intermediate layer is arranged directly between the respective battery cell and the frame elements, with the result that the respective battery cell is held in the battery cell space via the interlayer; and,
wherein the interlayer can be non-destructively elastically compressed owing to swelling of the directly adjoining battery cell to a swollen size, as a result of which, in spite of the swelling of the corresponding battery cell, a size of the battery cell space and outer dimensions of the battery cell pack remain constant.

12. The battery cell pack according to claim 11, wherein:
the respective battery cell is in the form of a solid-state battery cell.

13. The battery cell pack according to claim 11, wherein:
the respective interlayer comprises a material with a Poisson ratio (u) of less than 0.3.

14. The battery cell pack according to claim 11, wherein:
the respective interlayer comprises a foamed material.

15. The battery cell pack according to claim 11, wherein:
the interlayers are each configured such that an initial pressure of up to 10 bar acts on the respective battery cell when it is not swollen.

16. The battery cell pack according to claim 11, further comprising:
two pressing plates and two clamping elements, wherein the pressing plates delimit the battery cell pack along its direction of longitudinal extent and are clamped toward one another along the direction of longitudinal extent via the clamping elements, with the result that the battery cells, frame elements, and interlayers arranged between the pressing plates along the direction of longitudinal extent are clamped together.

17. The battery cell pack according to claim 11, wherein:
the frame elements are fastened to one another via a connecting element.

18. The battery cell pack according to claim 16, wherein:
the frame elements are fastened to the clamping elements via a further connecting element.

19. A battery comprising a battery cell pack according to claim 11.

20. The battery according to claim 19, further comprising:
a battery housing comprising a housing bottom part and a housing top part, wherein the battery cell pack and the housing bottom part are adhesively bonded to one another by means of an adhesive bond, and wherein the battery cell pack and the housing top part are adhesively bonded to one another by means of a further adhesive bond.
